(19) United States
(12) Patent Application Publication
(10) Pub. No.: US 2018/0315386 A1
(43) Pub. Date: Nov. 1, 2018

(54) LCD PIXEL DRIVER CIRCUIT AND TFT SUBSTRATE

(71) Applicant: Shenzhen China Star Optoelectronics Technology Co. Ltd., Shenzhen City (CN)

(72) Inventor: Qiming Gan, Shenzhen City (CN)

(21) Appl. No.: 15/533,998

(22) PCT Filed: Apr. 19, 2017
(86) PCT No.: PCT/CN2017/081036

§ 371 Date: Jun. 8, 2017

(30) Foreign Application Priority Data
Apr. 5, 2017 (CN) 201710218386.7

(51) Int. Cl. G09G 3/36

(52) U.S. Cl. CPC G09G 3/3648; G09G 2300/0426; G09G 3/3607; G09G 3/3674

(57) ABSTRACT

The invention provides an LCD pixel driver circuit and TFT substrate. The LCD pixel driver circuit comprises: a plurality of sub-pixels arranged in an array, each sub-pixel comprising: a main region TFT, a main region charge-sharing TFT, a secondary region TFT, a secondary charge-sharing TFT, a main region storage capacitor, a first secondary region storage capacitor, a main region LCD capacitor, and a secondary LC capacitor; the main and secondary region charge-sharing TFTs receiving respective the first and second array substrate common voltages. Through adjusting the first and second array substrate common voltages to adjust the LCD common voltage, the present invention can reduce the difficulty of controlling the best common voltage of LCD, and improve the control of the best common voltage efficiency and display effect.

### BACKGROUND OF THE INVENTION

### 1. Field of the Invention

The present invention relates to the field of display, and in particular to a liquid crystal display (LCD) pixel driver circuit and thin film transistor (TFT) substrate.

### 2. The Related Arts

The liquid crystal display (LCD) is the most widely used panel display. The liquid crystal (LC) panel is the core part of the LCD. The LCD panel usually comprises a color filter (CF) substrate, a thin film transistor (TFT) array substrate, and a liquid crystal layer sandwiched between the two substrates. In general, the array substrate and the CF substrate are respectively disposed with pixel electrodes and common electrodes. When a voltage is applied to the pixel electrodes and the common electrodes, an electrical field is generated in the LC layer. The electrical field determines the orientation of the LC molecules, leading to adjust the polarization of incident light to the LC layer to make the LC panel display an image.

To increase the viewing angle of the LCD, the known technology generally takes a multi-domain approach, which divides a sub-pixel into a plurality of regions and causes the LC in each region to be lean in a different direction after applying a voltage so that the viewing effect from the various directions is uniform and consistent. A variety of methods for implementing a multi-domain technique are available. Referring to FIG. 1, one method is to design the pixel electrode in a special shape, for example, a cross-like slit electrode structure with branch on the four main trunks of a cross. Specifically, the slit electrode structure comprises a vertical stripe 100′ and a horizontal stripe 200′, and the vertical stripe 100′ and horizontal stripe 200′ intersects perpendicularly with each other at the centers of the vertical stripe 100′ and horizontal stripe 200′, which divides the entire pixel electrode area into four domains. Each pixel electrode domain comprises a stripe branch (i.e., slit) 300′ forming ±45° or ±135° angle with a vertical stripe 100′ or horizontal stripe 200′, and each stripe branch 300′ is on the same plane as the vertical stripe 100′ and horizontal stripe 200′. The special pattern of the pixel electrode generates tilt electrical field to induce the LC molecules in different domain to lean towards different directions.

The special shape slit electrode, due to the same angle between the stripe branch and the horizontal or vertical stripe in each pixel electrode domain, will cause a certain extent of visual chromatic aberration or visual color deviation, and the transmission rate of the LC panel will also drop. For improvement, the prior art divides a pixel into a main region and a secondary region, disposes a separate main region pixel electrode in the main region and a separate secondary region pixel electrode. Both the main region pixel electrode and the sub-region region pixel electrode use the aforementioned special shape slit electrode to achieve eight-domain displaying. As shown in FIG. 2, each sub-pixel of the conventional LCD comprises: a main region thin film transistor (TFT) T100, a secondary region TFT T200, a charge-sharing TFT T300, a main region liquid crystal (LC) capacitor C100, a secondary region LC capacitor C200, a main region storage capacitor C300, a secondary region storage capacitor C400; the gate of the main region TFT T100 is electrically connected to the scan line Gate corresponding to the sub-pixel, the source electrically connected to the data line Data corresponding to the sub-pixel, and the drain electrically connected to one end of the main region LC capacitor C100; the gate of the secondary region TFT T200 is electrically connected to the scan line Gate corresponding to the sub-pixel, the source electrically connected to the data line Data corresponding to the sub-pixel, and the drain electrically connected to one end of the secondary region LC capacitor C200; the gate of the charge-sharing TFT T300 is electrically connected to the scan line Gate corresponding to the sub-pixel, the source electrically connected to the array substrate common voltage Acom, and the drain electrically connected to one end of the secondary region LC capacitor C200; the other ends of the main region LC capacitor C100 and the secondary region LC capacitor C200 are connected to the CF substrate common voltage Ccom; one end of the main region storage capacitor C300 is electrically connected to one end of the main region LC capacitor C100 and the other end connected to the array substrate common voltage Acom; one end of the secondary region storage capacitor C400 is electrically connected to one end of the secondary region LC capacitor C200 and the other end connected to the array substrate common voltage Acom; one end of the main region LC capacitor C100 is the main region pixel electrode 100, and one end of the secondary region LC capacitor C200 is the secondary region pixel electrode 200. When in operation, the main region TFT T100 charges the main region pixel electrode 100, the secondary region TFT T200 charges the secondary region pixel electrode 200, and the charge-sharing TFT T300 discharges the secondary region pixel electrode 200 so that the main region and the secondary region generate different voltages to increase the viewing angle. But, the in the aforementioned pixel structure, after the secondary region pixel electrode 200 discharges, the best common voltage (Vcom) for the main region and the secondary region will be different, which further increase the difficulty to balance control of best common voltage (Vcom) between the main region and the secondary region under the high resolution and high refreshing frequency, and greatly affects the display quality.

### SUMMARY OF THE INVENTION

The object of the present invention is to provide an LCD pixel driver circuit, able to reduce the difficulty to controlling best common voltage of LCD, improve the control of the best common voltage efficiency and display effect.

Another object of the present invention is to provide a TFT substrate, able to reduce the difficulty to controlling best common voltage of LCD, improve the control of the best common voltage efficiency and display effect.

To achieve the above object, the present invention provides a liquid crystal display (LCD) pixel driver circuit, comprising: a plurality of sub-pixels arranged in an array, a plurality of scan lines arranged in a parallel, interleaved and horizontal manner, and a plurality of data lines arranged in a parallel, interleaved and vertical manner;

each row of sub-pixels corresponding to a scan line, each column of sub-pixels corresponding to a data line, each sub-pixel comprising: a main region thin film transistor (TFT), a main region charge-sharing TFT, a secondary region TFT, a secondary charge-sharing TFT, a main region storage capacitor, a first secondary region storage capacitor, a main region liquid crystal (LC) capacitor, and a secondary LC capacitor;

the main region TFT having a gate connected to the scan line corresponding to the sub-pixel, a source connected to the data line corresponding to the sub-pixel, and a drain connected to one end of the main region LC capacitor; the main region storage capacitor having one end connected to one end of the main region LC capacitor and the other connected to a first array substrate common voltage; the main region LC capacitor having the other end connected to a color filter (CF) substrate common voltage; the main region charge-sharing TFT having a gate connected to the scan line corresponding to the sub-pixel, a source connected to the one end of the main region LC capacitor, and a drain connected to a second array substrate common voltage;

the secondary region TFT having a gate connected to the scan line corresponding to the sub-pixel, a source connected to the data line corresponding to the sub-pixel, and a drain connected to one end of the secondary region LC capacitor; the first secondary region storage capacitor having one end connected to one end of the secondary region LC capacitor and the other connected to the second array substrate common voltage; the secondary region LC capacitor having the other end connected to the CF substrate common voltage; the secondary region charge-sharing TFT having a gate connected to the scan line corresponding to the sub-pixel, a source connected to one end of the secondary region LC capacitor, and a drain connected to the first array substrate common voltage.

According to a preferred embodiment of the present invention, the first array substrate common voltage is larger or smaller than the second array substrate common voltage.

According to a preferred embodiment of the present invention, each sub-pixel further comprises: a second secondary region storage capacitor, the secondary region charge-sharing TFT having the drain connected to receive the first array substrate common voltage through the second secondary region storage capacitor.

According to a preferred embodiment of the present invention, one end of the main region LC capacitor is a main region pixel electrode, and the other end is the CF substrate common voltage; one end of the secondary region LC capacitor is a secondary region pixel electrode, and the other end is the CF substrate common voltage.

According to a preferred embodiment of the present invention, the main region pixel electrode and the secondary region pixel electrode are both of a cross-like slit electrode structure with branches on four main trunks of a cross, and made of indium-tin-oxide (ITO).

The present invention also provides a thin film transistor (TFT) substrate, comprising: a base substrate, a plurality of sub-pixels arranged in an array on the base substrate, a plurality of scan lines arranged in a parallel, interleaved and horizontal manner, and a plurality of data lines arranged in a parallel, interleaved and vertical manner;

each row of sub-pixels corresponding to a scan line, each column of sub-pixels corresponding to a data line, each sub-pixel comprising: a main region thin film transistor (TFT), a main region charge-sharing TFT, a secondary region TFT, a secondary charge-sharing TFT, a main region storage capacitor, a first secondary region storage capacitor, a main region pixel electrode, and a secondary region pixel electrode;

the main region TFT having a gate connected to the scan line corresponding to the sub-pixel, a source connected to the data line corresponding to the sub-pixel, and a drain connected to the main region pixel electrode; the main region storage capacitor having one end connected to the main region pixel electrode and the other connected to a first array substrate common voltage; the main region charge-sharing TFT having a gate connected to the scan line corresponding to the sub-pixel, a source connected to the main region pixel electrode, and a drain connected to a second array substrate common voltage;

the secondary region TFT having a gate connected to the scan line corresponding to the sub-pixel, a source connected to the data line corresponding to the sub-pixel, and a drain connected to the secondary region pixel electrode; the first secondary region storage capacitor having one end connected to the secondary region pixel electrode and the other connected to the second array substrate common voltage; the secondary region charge-sharing TFT having a gate connected to the scan line corresponding to the sub-pixel, a source connected to the secondary region pixel electrode, and a drain connected to the first array substrate common voltage.

According to a preferred embodiment of the present invention, the first array substrate common voltage is larger or smaller than the second array substrate common voltage.

According to a preferred embodiment of the present invention, each sub-pixel further comprises: a second secondary region storage capacitor, the secondary region charge-sharing TFT having the drain connected to receive the first array substrate common voltage through the second secondary region storage capacitor.

According to a preferred embodiment of the present invention, the main region pixel electrode and the secondary region pixel electrode are both of a cross-like slit electrode structure with branch on four main trunks of a cross, and made of indium-tin-oxide (ITO).

The present invention further provides a liquid crystal display (LCD) pixel driver circuit, comprising: a plurality of sub-pixels arranged in an array, a plurality of scan lines arranged in a parallel, interleaved and horizontal manner, and a plurality of data lines arranged in a parallel, interleaved and vertical manner;

each row of sub-pixels corresponding to a scan line, each column of sub-pixels corresponding to a data line, each sub-pixel comprising: a main region thin film transistor (TFT), a main region charge-sharing TFT, a secondary region TFT, a secondary charge-sharing TFT, a main region storage capacitor, a first secondary region storage capacitor, a main region liquid crystal (LC) capacitor, and a secondary LC capacitor;

the main region TFT having a gate connected to the scan line corresponding to the sub-pixel, a source connected to the data line corresponding to the sub-pixel, and a drain connected to one end of the main region LC capacitor; the main region storage capacitor having one end connected to one end of the main region LC capacitor and the other connected to a first array substrate common voltage; the main region LC capacitor having the other end connected to a color filter (CF) substrate common voltage; the main region charge-sharing TFT having a gate connected to the scan line corresponding to the sub-pixel, a source connected to the one end of the main region LC capacitor, and a drain connected to a second array substrate common voltage;

the secondary region TFT having a gate connected to the scan line corresponding to the sub-pixel, a source connected to the data line corresponding to the sub-pixel, and a drain connected to one end of the secondary region LC capacitor; the first secondary region storage capacitor having one end connected to one end of the secondary region LC capacitor and the other connected to the second array substrate common voltage; the secondary region LC capacitor having the other end connected to the CF substrate common voltage; the secondary region charge-sharing TFT having a gate connected to the scan line corresponding to the sub-pixel, a source connected to one end of the secondary region LC capacitor, and a drain connected to the first array substrate common voltage;

wherein the first array substrate common voltage being larger or smaller than the second array substrate common voltage;

wherein one end of the main region LC capacitor being a main region pixel electrode, and the other end being the CF substrate common voltage;

one end of the secondary region LC capacitor being a secondary region pixel electrode, and the other end beings the CF substrate common voltage.

Compared to the known techniques, the present invention provides the following advantages: the present invention provides an LCD pixel driver circuit, comprising: a plurality of sub-pixels arranged in an array, a plurality of scan lines arranged in a parallel, interleaved and horizontal manner, and a plurality of data lines arranged in a parallel, interleaved and vertical manner; each row of sub-pixels corresponding to a scan line, each column of sub-pixels corresponding to a data line, each sub-pixel comprising: a main region TFT, a main region charge-sharing TFT, a secondary region TFT, a secondary charge-sharing TFT, a main region storage capacitor, a first secondary region storage capacitor, a main region LCD capacitor, and a secondary LC capacitor; the main and secondary region charge-sharing TFTs receiving respective the first and second array substrate common voltages. Through adjusting the first and second array substrate common voltages to adjust the LCD common voltage, the present invention can reduce the difficulty of controlling the best common voltage of LCD, and improve the control of the best common voltage efficiency and display effect. The present invention also provides a TFT substrate, able to reduce the difficulty of controlling the best common voltage of LCD, and improve the control of the best common voltage efficiency and display effect.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing a known cross-like slit electrode structure with branches;

FIG. 2 is a schematic view showing a known LCD pixel driver circuit;

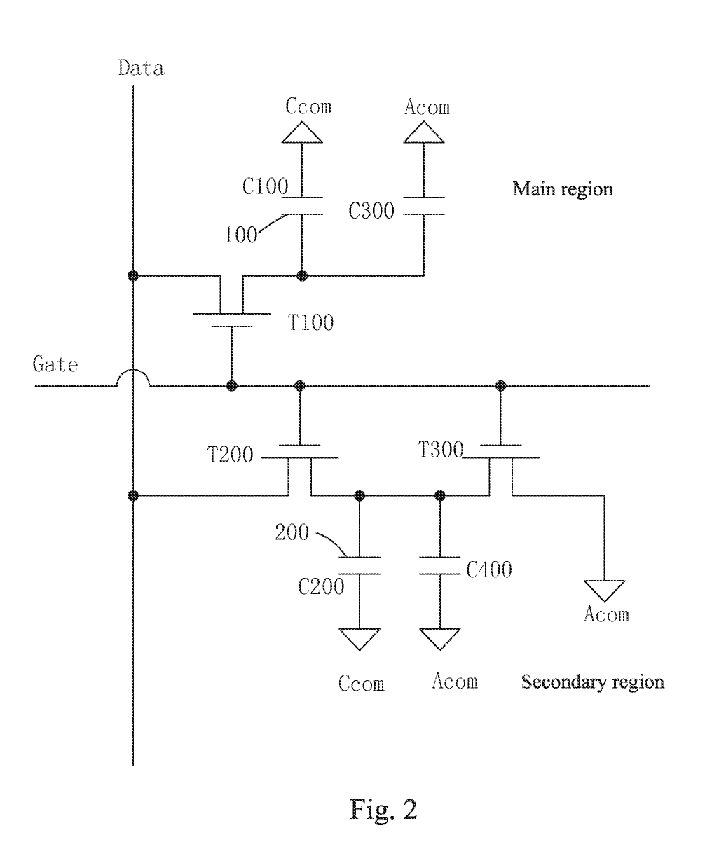

FIG. 3 is a schematic view showing the first embodiment of the LCD pixel driver circuit according to the present invention;

FIG. 4 is a schematic view showing the second embodiment of the LCD pixel driver circuit according to the present invention;

FIG. 5 is a schematic view showing the first embodiment of the TFT substrate according to the present invention;

FIG. 6 is a schematic view showing the second embodiment of the TFT substrate according to the present invention.

### DETAILED DESCRIPTION OF THE PREFERRED EMBODIMENTS

To further explain the technical means and effect of the present invention, the following refers to embodiments and drawings for detailed description.

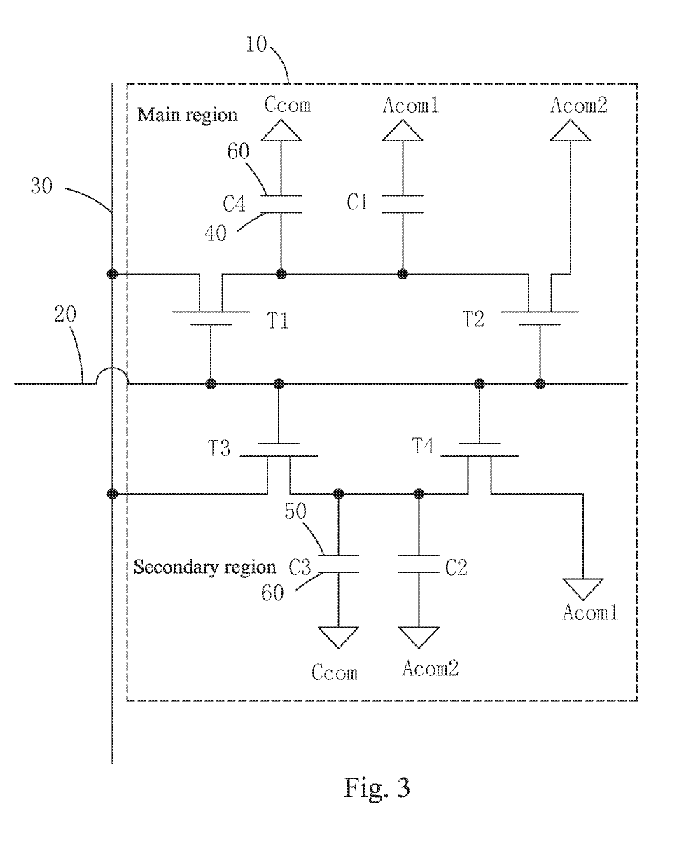

Refer to FIG. 3. The present invention provides an array substrate, comprising: a plurality of sub-pixels 10 arranged in an array, a plurality of scan lines 20 arranged in a parallel, interleaved and horizontal manner, and a plurality of data lines 30 arranged in a parallel, interleaved and vertical manner;

each row of sub-pixels 10 corresponding to a scan line 20, each column of sub-pixels 10 corresponding to a data line 30, each sub-pixel 10 comprising: a main region thin film transistor (TFT) T1, a main region charge-sharing TFT T2, a secondary region TFT T3, a secondary charge-sharing TFT T4, a main region storage capacitor C1, a first secondary region storage capacitor C2, a main region liquid crystal (LC) capacitor C4, and a secondary LC capacitor C3;

the main region TFT T1 having a gate connected to the scan line 20 corresponding to the sub-pixel 10, a source connected to the data line 30 corresponding to the sub-pixel 10, and a drain connected to one end of the main region LC capacitor C4; the main region storage capacitor C1 having one end connected to one end of the main region LC capacitor C4 and the other connected to a first array substrate common voltage Acom1; the main region LC capacitor C4 having the other end connected to a color filter (CF) substrate common voltage Ccom; the main region charge-sharing TFT T2 having a gate connected to the scan line 20 corresponding to the sub-pixel 10, a source connected to the one end of the main region LC capacitor C4, and a drain connected to a second array substrate common voltage Acom2;

the secondary region TFT T3 having a gate connected to the scan line 20 corresponding to the sub-pixel 10, a source connected to the data line 30 corresponding to the sub-pixel 10, and a drain connected to one end of the secondary region LC capacitor C3; the first secondary region storage capacitor C2 having one end connected to one end of the secondary region LC capacitor C3 and the other connected to the second array substrate common voltage Acom2; the secondary region LC capacitor C3 having the other end connected to the CF substrate common voltage Ccom; the secondary region charge-sharing TFT T4 having a gate connected to the scan line 20 corresponding to the sub-pixel n10, a source connected to one end of the secondary region LC capacitor C3, and a drain connected to the first array substrate common voltage Acom1.

It should be noted, in that the LCD pixel driver circuit, the first array substrate common voltage Acom1 and the second array substrate common voltage Acom2 are usually different. That is, the first array substrate common voltage Acom1 is larger or smaller than the second array substrate common voltage Acom2. Compared to known technology, the LCD pixel driver circuit of the present invention is disposed with the first array substrate common voltage Acom1 and the second array substrate common voltage Acom2, and the main region of the sub-pixel is disposed with a main region charge-sharing TFT T2. When in operation, the main region LC capacitor C4 is discharged through the main region charge-sharing TFT T2 and the second array substrate common voltage Acom2, and the secondary region LC capacitor C3 is discharged through the secondary region charge-sharing TFT T4 and the first array substrate common voltage Acom1. As such, by controlling the voltages of the first and second array substrate common voltages Acom1, Acom2 to control the holding voltage ratio between the main region and the secondary region and the common voltage of LCD, the balance between the best common voltage between the main region and the secondary region is achieved. Specifically, the voltages of the first and second array substrate common voltages Acom1, Acom2 can be adjusted depending on the actual situation of the LCD pixel.

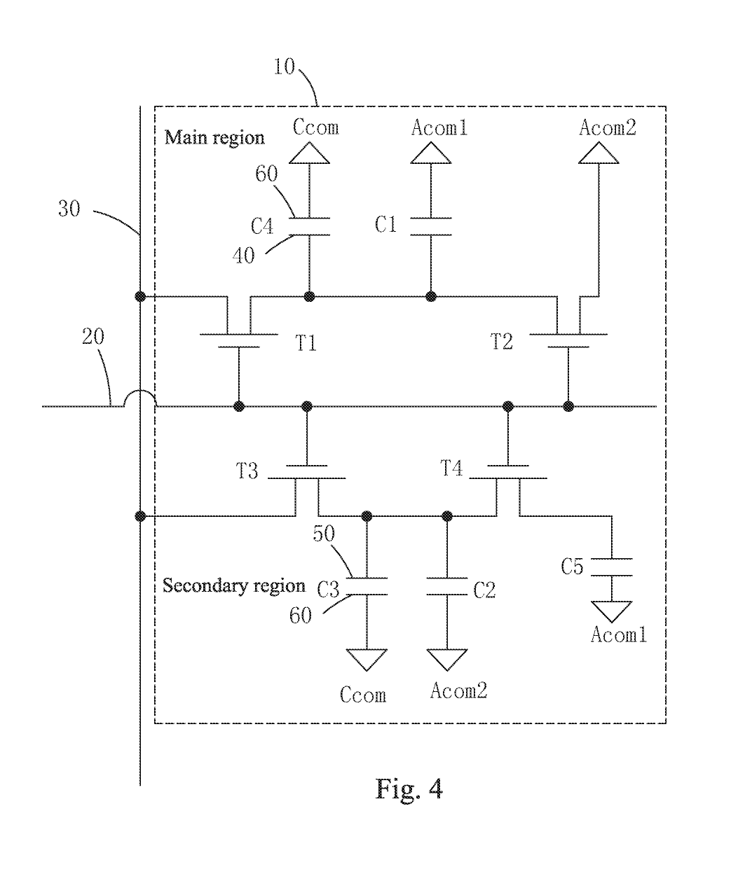

Furthermore, refer to FIG. 4. In the second embodiment of the present invention, each sub-pixel 10 further comprises: a second secondary region storage capacitor C5, the secondary region charge-sharing TFT T4 having the drain connected to receive the first array substrate common voltage Acom1 through the second secondary region storage capacitor C5. The charging rate of the secondary region LC capacitor C3 can be reduced by the second secondary region storage capacitor C5, so that the voltage difference between one end of the secondary region LC capacitor C3 and the main region LC capacitor C4 becomes greater.

Specifically, one end of the main region LC capacitor C4 is a main region pixel electrode 40, and the other end is the CF substrate common voltage 60; one end of the secondary region LC capacitor C3 is a secondary region pixel electrode 50, and the other end is the CF substrate common voltage 60.

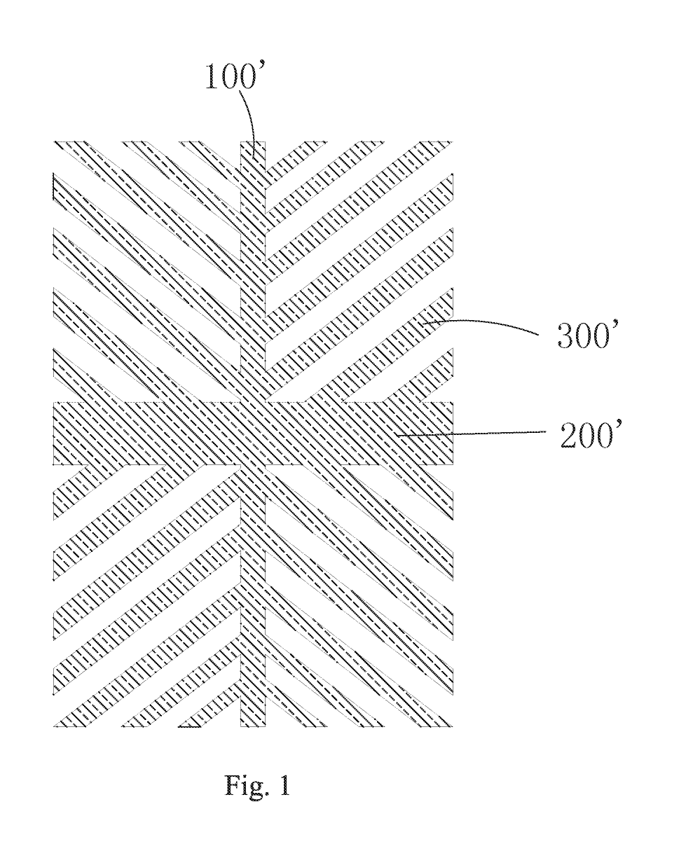

Specifically, referring to FIG. 1, the main region pixel electrode 40 and the secondary region pixel electrode 50 are both of a cross-like slit electrode structure with branch on four main trunks of a cross. By designing both the main region pixel electrode 40 and the secondary region pixel electrode 50 as cross-like slit electrode structure with branch on four main trunks of a cross, the present invention realizes 8-domain displaying, enlarges the LCD viewing angle as well as improve color shift of the LCD.

Preferably, the main region pixel electrode 40 and the secondary region pixel electrode 50 are both made of indium-tin-oxide (ITO).

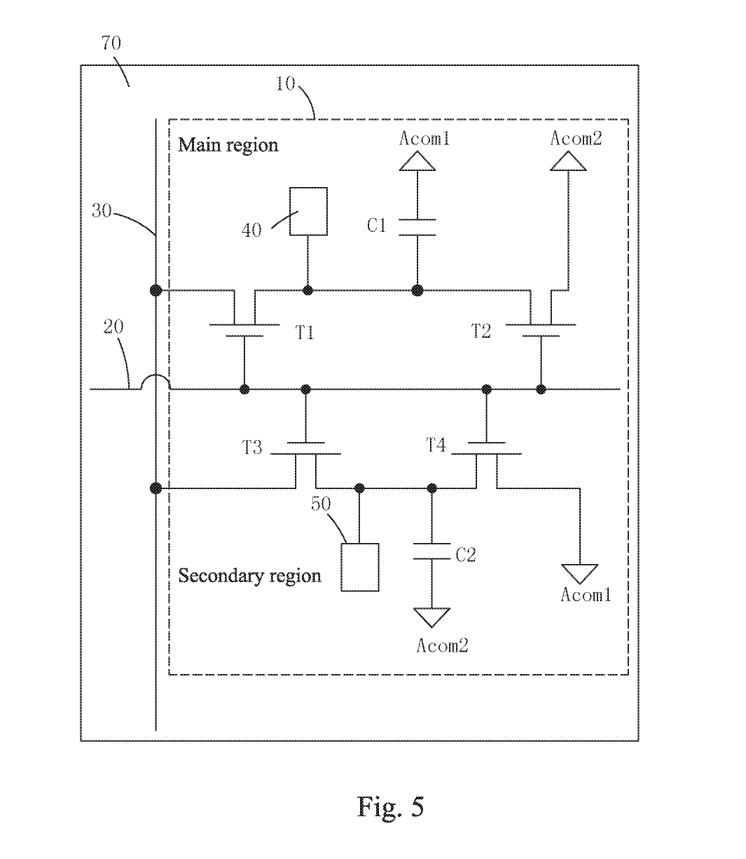

Refer to FIG. 5, based on the aforementioned LCD pixel driver circuit, the present invention also provides a thin film transistor (TFT) substrate. In the first embodiment, the TFT substrate comprises: a base substrate 70, a plurality of sub-pixels 10 arranged in an array on the base substrate 70, a plurality of scan lines 20 arranged in a parallel, interleaved and horizontal manner, and a plurality of data lines 30 arranged in a parallel, interleaved and vertical manner;

each row of sub-pixels 10 corresponding to a scan line 20, each column of sub-pixels 10 corresponding to a data line 30, each sub-pixel comprising: a main region thin film transistor (TFT) T1, a main region charge-sharing TFT T2, a secondary region TFT T3, a secondary charge-sharing TFT T4, a main region storage capacitor C1, a first secondary region storage capacitor C2, a main region pixel electrode 40, and a secondary region pixel electrode 50;

the main region TFT T1 having a gate connected to the scan line 20 corresponding to the sub-pixel 10, a source connected to the data line 30 corresponding to the sub-pixel 10, and a drain connected to the main region pixel electrode 40; the main region storage capacitor C1 having one end connected to the main region pixel electrode 40 and the other connected to a first array substrate common voltage Acom1; the main region charge-sharing TFTT2 having a gate connected to the scan line 20 corresponding to the sub-pixel 10, a source connected to the main region pixel electrode 40, and a drain connected to a second array substrate common voltage Acom2;

the secondary region TFT T3 having a gate connected to the scan line 20 corresponding to the sub-pixel 10, a source connected to the data line 30 corresponding to the sub-pixel 10, and a drain connected to the secondary region pixel electrode 50; the first secondary region storage capacitor C2 having one end connected to the secondary region pixel electrode 50 and the other connected to the second array substrate common voltage Acom2; the secondary region charge-sharing TFT T4 having a gate connected to the scan line 20 corresponding to the sub-pixel 10, a source connected to the secondary region pixel electrode 50, and a drain connected to the first array substrate common voltage Acom1.

It should be noted, in that the TFT substrate, the first array substrate common voltage Acom1 and the second array substrate common voltage Acom2 are usually different. That is, the first array substrate common voltage Acom1 is larger or smaller than the second array substrate common voltage Acom2. Compared to known technology, the TFT substrate of the present invention is disposed with the first array substrate common voltage Acom1 and the second array substrate common voltage Acom2, and the main region of the sub-pixel is disposed with a main region charge-sharing TFT T2. When in operation, the main region pixel electrode 40 is discharged through the main region charge-sharing TFT T2 and the second array substrate common voltage Acom2, and the secondary region pixel electrode 50 is discharged through the secondary region charge-sharing TFT T4 and the first array substrate common voltage Acom1; so that when the main region pixel electrode 40 and the secondary region pixel electrode 50 have different voltages, by controlling the voltages of the first and second array substrate common voltages Acom1, Acom2 to control the holding voltage ratio between the main region and the secondary region and the common voltage of LCD, the balance between the best common voltage between the main region and the secondary region is achieved. Specifically, the voltages of the first and second array substrate common voltages Acom1, Acom2 can be adjusted depending on the actual situation of the LCD pixel.

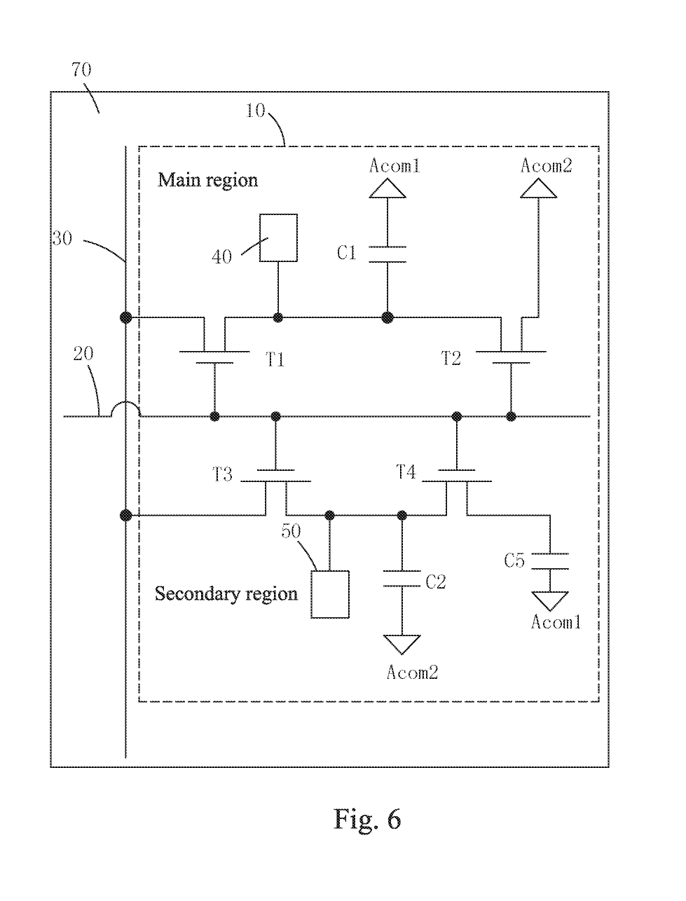

Furthermore, refer to FIG. 6. In the second embodiment of the present invention, each sub-pixel 10 further comprises: a second secondary region storage capacitor C5, the secondary region charge-sharing TFT T4 having the drain connected to receive the first array substrate common voltage Acom1 through the second secondary region storage capacitor C5. The charging rate of the secondary region pixel electrode 50 can be reduced by the second secondary region storage capacitor C5, so that the voltage difference between one end of the main region pixel electrode 40 and the secondary region pixel electrode 50 becomes greater.

Specifically, referring to FIG. 1, the main region pixel electrode 40 and the secondary region pixel electrode 50 are both of a cross-like slit electrode structure with branch on four main trunks of a cross. By designing both the main region pixel electrode 40 and the secondary region pixel electrode 50 as cross-like slit electrode structure with branch on four main trunks of a cross, the present invention realizes 8-domain displaying, enlarges the LCD viewing angle as well as improve color shift of the LCD.

Preferably, the main region pixel electrode 40 and the secondary region pixel electrode 50 are both made of indium-tin-oxide (ITO).

In summary, the present invention provides an LCD pixel driver circuit, comprising: a plurality of sub-pixels arranged in an array, a plurality of scan lines arranged in a parallel, interleaved and horizontal manner, and a plurality of data lines arranged in a parallel, interleaved and vertical manner; each row of sub-pixels corresponding to a scan line, each column of sub-pixels corresponding to a data line, each sub-pixel comprising: a main region TFT, a main region charge-sharing TFT, a secondary region TFT, a secondary charge-sharing TFT, a main region storage capacitor, a first secondary region storage capacitor, a main region LCD capacitor, and a secondary LC capacitor; the main and secondary region charge-sharing TFTs receiving respective the first and second array substrate common voltages. Through adjusting the first and second array substrate common voltages to adjust the LCD common voltage, the present invention can reduce the difficulty of controlling the best common voltage of LCD, and improve the control of the best common voltage efficiency and display effect. The present invention also provides a TFT substrate, able to reduce the difficulty of controlling the best common voltage of LCD, and improve the control of the best common voltage efficiency and display effect.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A liquid crystal display (LCD) pixel driver circuit, comprising: a plurality of sub-pixels arranged in an array, a plurality of scan lines arranged in a parallel, interleaved and horizontal manner, and a plurality of data lines arranged in a parallel, interleaved and vertical manner;
each row of sub-pixels corresponding to a scan line, each column of sub-pixels corresponding to a data line, each sub-pixel comprising: a main region thin film transistor (TFT), a main region charge-sharing TFT, a secondary region TFT, a secondary charge-sharing TFT, a main region storage capacitor, a first secondary region storage capacitor, a main region liquid crystal (LC) capacitor, and a secondary LC capacitor;
the main region TFT having a gate connected to the scan line corresponding to the sub-pixel, a source connected to the data line corresponding to the sub-pixel, and a drain connected to one end of the main region LC capacitor; the main region storage capacitor having one end connected to one end of the main region LC capacitor and the other connected to a first array substrate common voltage; the main region LC capacitor having the other end connected to a color filter (CF) substrate common voltage; the main region charge-sharing TFT having a gate connected to the scan line corresponding to the sub-pixel, a source connected to the one end of the main region LC capacitor, and a drain connected to a second array substrate common voltage;
the secondary region TFT having a gate connected to the scan line corresponding to the sub-pixel, a source connected to the data line corresponding to the sub-pixel, and a drain connected to one end of the secondary region LC capacitor; the first secondary region storage capacitor having one end connected to one end of the secondary region LC capacitor and the other connected to the second array substrate common voltage; the secondary region LC capacitor having the other end connected to the CF substrate common voltage; the secondary region charge-sharing TFT having a gate connected to the scan line corresponding to the sub-pixel, a source connected to one end of the secondary region LC capacitor, and a drain connected to the first array substrate common voltage.

2. The LCD pixel driver circuit as claimed in claim 1, wherein the first array substrate common voltage is larger or smaller than the second array substrate common voltage.

3. The LCD pixel driver circuit as claimed in claim 1, wherein each sub-pixel further comprises: a second secondary region storage capacitor, the secondary region charge-sharing TFT having the drain connected to receive the first array substrate common voltage through the second secondary region storage capacitor.

4. The LCD pixel driver circuit as claimed in claim 1, wherein one end of the main region LC capacitor is a main region pixel electrode, and the other end is the CF substrate common voltage;
one end of the secondary region LC capacitor is a secondary region pixel electrode, and the other end is the CF substrate common voltage.

5. The LCD pixel driver circuit as claimed in claim 4, wherein the main region pixel electrode and the secondary region pixel electrode are both of a cross-like slit electrode structure with branches on four main trunks of a cross, and made of indium-tin-oxide (ITO).

6. A thin film transistor (TFT) substrate, comprising: a base substrate, a plurality of sub-pixels arranged in an array on the base substrate, a plurality of scan lines arranged in a parallel, interleaved and horizontal manner, and a plurality of data lines arranged in a parallel, interleaved and vertical manner;
each row of sub-pixels corresponding to a scan line, each column of sub-pixels corresponding to a data line, each sub-pixel comprising: a main region thin film transistor (TFT), a main region charge-sharing TFT, a secondary region TFT, a secondary charge-sharing TFT, a main region storage capacitor, a first secondary region storage capacitor, a main region pixel electrode, and a secondary region pixel electrode;
the main region TFT having a gate connected to the scan line corresponding to the sub-pixel, a source connected to the data line corresponding to the sub-pixel, and a drain connected to the main region pixel electrode; the main region storage capacitor having one end connected to the main region pixel electrode and the other connected to a first array substrate common voltage; the main region charge-sharing TFT having a gate connected to the scan line corresponding to the sub-pixel, a source connected to the main region pixel electrode, and a drain connected to a second array substrate common voltage;
the secondary region TFT having a gate connected to the scan line corresponding to the sub-pixel, a source connected to the data line corresponding to the sub-pixel, and a drain connected to the secondary region pixel electrode; the first secondary region storage capacitor having one end connected to the secondary region pixel electrode and the other connected to the second array substrate common voltage; the secondary region charge-sharing TFT having a gate connected to the scan line corresponding to the sub-pixel, a source connected to the secondary region pixel electrode, and a drain connected to the first array substrate common voltage.

7. The TFT substrate as claimed in claim 6, wherein the first array substrate common voltage is larger or smaller than the second array substrate common voltage.

8. The TFT substrate as claimed in claim 6, wherein each sub-pixel further comprises: a second secondary region storage capacitor, the secondary region charge-sharing TFT having the drain connected to receive the first array substrate common voltage through the second secondary region storage capacitor.

9. The TFT substrate as claimed in claim 6, wherein the main region pixel electrode and the secondary region pixel electrode are both of a cross-like slit electrode structure with branches on four main trunks of a cross, and made of indium-tin-oxide (ITO).

10. A liquid crystal display (LCD) pixel driver circuit, comprising: a plurality of sub-pixels arranged in an array, a plurality of scan lines arranged in a parallel, interleaved and horizontal manner, and a plurality of data lines arranged in a parallel, interleaved and vertical manner;
each row of sub-pixels corresponding to a scan line, each column of sub-pixels corresponding to a data line, each sub-pixel comprising: a main region thin film transistor (TFT), a main region charge-sharing TFT, a secondary region TFT, a secondary charge-sharing TFT, a main region storage capacitor, a first secondary region storage capacitor, a main region liquid crystal (LC) capacitor, and a secondary LC capacitor;
the main region TFT having a gate connected to the scan line corresponding to the sub-pixel, a source connected to the data line corresponding to the sub-pixel, and a drain connected to one end of the main region LC capacitor; the main region storage capacitor having one end connected to one end of the main region LC capacitor and the other connected to a first array substrate common voltage; the main region LC capacitor having the other end connected to a color filter (CF) substrate common voltage; the main region charge-sharing TFT having a gate connected to the scan line corresponding to the sub-pixel, a source connected to the one end of the main region LC capacitor, and a drain connected to a second array substrate common voltage;
the secondary region TFT having a gate connected to the scan line corresponding to the sub-pixel, a source connected to the data line corresponding to the sub-pixel, and a drain connected to one end of the secondary region LC capacitor; the first secondary region storage capacitor having one end connected to one end of the secondary region LC capacitor and the other connected to the second array substrate common voltage; the secondary region LC capacitor having the other end connected to the CF substrate common voltage; the secondary region charge-sharing TFT having a gate connected to the scan line corresponding to the sub-pixel, a source connected to one end of the secondary region LC capacitor, and a drain connected to the first array substrate common voltage;
wherein the first array substrate common voltage being larger or smaller than the second array substrate common voltage;
wherein one end of the main region LC capacitor being a main region pixel electrode, and the other end being the CF substrate common voltage;
one end of the secondary region LC capacitor being a secondary region pixel electrode, and the other end being the CF substrate common voltage.

11. The LCD pixel driver circuit as claimed in claim 10, wherein each sub-pixel further comprises: a second secondary region storage capacitor, the secondary region charge-sharing TFT having the drain connected to receive the first array substrate common voltage through the second secondary region storage capacitor.

12. The LCD pixel driver circuit as claimed in claim 10, wherein the main region pixel electrode and the secondary region pixel electrode are both of a cross-like slit electrode structure with branches on four main trunks of a cross, and made of indium-tin-oxide (ITO).
